(19) United States
(12) Patent Application Publication
(10) Pub. No.: US 2016/0249640 A1
(43) Pub. Date: Sep. 1, 2016

(54) METHODS OF FEEDING YOUNG ANIMALS

(71) Applicant: MILK PRODUCTS LLC, Chilton, WI (US)

(72) Inventors: Julian Olson, Highland Village, TX (US); David Kuehnel, Newton, WI (US); David L. Cook, Harrisonville, MO (US); Sara Sievert, De Pere, WI (US)

(21) Appl. No.: 14/634,317

(22) Filed: Feb. 27, 2015

(51) Int. Cl. A23K 1/18

(52) U.S. Cl. CPC A23K 1/1893

(57) ABSTRACT

Whole milk and at least one additional nutrient source are mixed to reach an admixture of about 10 to about 17 percent total solids on a dry matter basis, where about 20 to about 26 percent of the total solids is protein, and where about 16 to about 25 percent of the total solids is fat. The admixture and a starter feed are fed to one or more young animals so that they receive at least 0.75 lbs. of total solids on a dry matter basis per day from the admixture. In response to ingesting the admixture, starter feed intake is increased and improved performance results. The level of the additional nutrient source(s) in the admixture may be calculated based on a compositional analysis of the available whole milk and a dietary target for the young animals. The compositional analysis may be performed at the location where the young animals are fed.

### TECHNICAL FIELD

The present disclosure relates generally to methods of formulating diets for feeding young animals, and more particularly to formulating liquid rations containing an admixture of whole milk and additional nutrient sources according to dietary targets.

### BACKGROUND

Livestock animals are a commodity and are raised to produce milk and meat. The time it takes livestock to mature, particularly to gain weight, is important when assessing whether the animal is ready to produce milk or is ready for market. A number of feeding systems have been used to enhance weight gain of livestock beginning at a young age, and may include feeding techniques prior to and after weaning. Such techniques may involve providing milk replacers to the animals that generally mimic the milk produced from the post-partum parent animal in terms of protein, fat and carbohydrate content. The milk replacer may be supplemented with vitamins, minerals, medication and other compositions that may benefit the young animals. This may, for example, reduce the age of freshening or the onset of lactation of a dairy cow, thereby reducing the cost of milk production. Increased weight gain of livestock from an early age may also reduce the cost of beef production.

A concern for producers is whether livestock animals are receiving adequate nutrients. When the livestock animals refuse feed, intake is decreased, which may be problematic from both the standpoint of the health of the animal and to the cost of milk or meat production. Differences in feed intake by animals impact rate of weight gain and ultimately body size. Smaller animals are more difficult to adequately manage due to their specific housing, dietary and husbandry needs.

Although various feeding systems have been practiced to enhance weight gain, these feeding systems have not optimized methods for increasing the rate and uniformity of weight gain by the livestock animals from a young age. Accordingly, producers are in need of new approaches to feeding young livestock animals as well as other young animals that enhance weight gain rates and/or increase feed efficiency.

### SUMMARY

Methods of feeding young animals in a daily feeding program involve, on a daily basis, determining a volume of whole milk available for feeding to the one or more young animals in the daily nutrition program, where the whole milk comprises one or more of non-saleable milk or saleable milk; determining a number of the one or more animals to be fed the available whole milk in the program; in a location where the young animals are fed, determining a compositional level of protein, fat and total solids in the available whole milk; calculating an amount of at least one additional nutrient source for incorporating with the whole milk to reach an admixture of about 10 to about 17 percent total solids on a dry matter basis, where about 20 to about 26 percent of the total solids is protein, and where about 16 to about 25 percent of the total solids is fat; admixing at least one additional nutrient source with the whole milk; and feeding the admixture to the one or more young animals in the program, where the volume of the available whole milk, the composition of the available whole milk, and the number of the one or more young animals in the program is variable over a course of the program such that the amount calculated dynamically changes over the course of the program.

Variations in such methods may involve offering starter feed on an ad libitum basis, and in response to ingesting the admixture and starter feed, at least one young animal experiences improved performance. The admixture may include about 11 to 14 percent total solids on a dry matter basis. At least 30 to about 75 percent of the admixture may be whole milk. For example, the admixture may contain at least about 0.75 lbs. total solids on a dry matter basis per young animal per feeding, and at least 0.50 lbs. of the total solids may be from whole milk. In such an admixture at least about 0.25 lbs. of the total solids may be from an additional nutrient source, which may include a milk replacer, a balancer, an extender or combinations. When a balancer, the balancer may include an elevated level of protein relative to a level of fat. Whole milk in the various admixtures may account for at least about 30 percent of the admixture. The one or more young animals may be one or more calves and the program may end for each calf once weaned. In some alternatives, the step of determining a compositional level of protein, fat and total solids in the available whole milk involves analyzing the whole milk using an electronic analyzer at the location where the young animals are fed.

Other methods of feeding one or more young animals in a feeding program may involve, in a location where the young animals are fed, analyzing a composition of available whole milk to be fed to the one or more young animals, where results of the compositional analysis include at least one of fat, protein, total solids or lactose, and where the composition of the available whole milk is variable over a course of the feeding program; using the compositional analysis results to calculate an amount of one or more additional nutrients for incorporating with the available whole milk analyzed to reach an admixture of about 10 to about 17 percent total solids on a dry matter basis, where about 20 to about 26 percent of the total solids is protein, and where about 16 to about 25 percent of the total solids is fat; and feeding the admixture and a starter feed to the one or more young animals, where the starter feed is fed ad libitum, and where in response to ingesting the admixture, the one or more young animals increases starter feed intake, and at least one of the one or more young animals experiences improved performance. The improved performance may include improved body weight gain, improved average daily gain, improved hip height gain or combinations.

Variations in such methods may include that the starter feed includes about 18 percent crude protein; that the one or more additional nutrients comprises a nutrient powder containing a blend of protein and fat; that the young animals are calves and the program ends at weaning; that the admixture contains at least about 0.75 lbs. total solids on a dry matter basis per young animal per feeding, and that at least 0.50 lbs. of the total solids is from whole milk; that the whole milk accounts for at least about 30 percent of the admixture; that at least one additional nutrient source includes a balancer, and where the balancer includes an elevated level of protein relative to a level of fat.

Other exemplary methods of feeding a young animal involve mixing whole milk and at least one of a milk replacer, a balancer or an extender to reach an admixture of about 10 to about 17 percent total solids on a dry matter basis, where about 20 to about 26 percent of the total solids is protein, and where about 16 to about 25 percent of the total solids is fat; and feeding the admixture and a starter feed to the one or more young animals, where the admixture is fed such that the young animal receives at least 0.75 lbs. of total solids on a dry matter basis per day, where the starter feed is fed ad libitum, and where in response to ingesting the admixture, the one or more young animals increases starter feed intake, and at least one of the one or more young animals experiences improved performance.

### DETAILED DESCRIPTION

Overview

The methods of formulating liquid diets and of feeding liquid diets of the present disclosure are applicable to young animals such as calves, lambs, kids, other young ruminants, piglets, other young livestock animals, foals, young zoo animals and young companion animals. In addition, the young animals may be fed individually or in a group setting. At the beginning stages of life young animals rely solely or heavily on a liquid diet for delivering dietary nutrients required to survive, maintain and/or grow. Eventually the young animal is weaned from the liquid diet and ingests solid feed, such as forage and grains in the case of livestock animals including ruminants. Prior to being weaned, the animal may ingest a primarily liquid diet while intaking feed such as starter feed. The present disclosure is applicable to formulating liquid diets for young animals prior to and during weaning. It has been found that liquid diets that take into account the nutrients contained in whole milk fed to the young animal, as well as the nutrients contained in milk replacers, extenders, balancers and/or fortifiers provide a targeted approach to achieving a desired animal performance in the young animal.

In prior approaches, young animals separated from their mother at birth are fed milk replacers for nourishment until the animals are weaned. Milk replacers typically contain a blend of protein and fat in an amount that mimics milk produced by the female of the species. These milk replacers are known as conventional milk replacers and they generally contain less than 25 percent protein by dry weight and are fed in conventional settings, e.g., at a rate of up to about 1.5 pounds per head/day on a dry weight basis. Most conventional milk replacers contain all-milk proteins that are typically derived from cow's milk. Some conventional milk replacers contain non-milk proteins from other sources.

In other approaches, young animals in these settings are fed high potential milk replacers that typically contain at least 25 percent protein by dry weight, which may be provided by milk proteins, non-milk proteins or a combination of non-milk proteins and milk proteins. Full potential milk replacers are commonly fed in enhanced settings, e.g., at a rate of about 1.6 pounds per head/day on a dry weight basis.

In each of these prior approaches, young animals are offered starter feed, which is a solid feed containing a mixture of grains and nutrients, that the animal ingests ad libitum. The rate of ingestion of starter feed is generally low during the first few weeks of life and gradually increases through weaning as the animal naturally transitions from an all liquid diet to solids diet comprised of forages and grains. Starter feed may contain about 18 to about 22 percent crude protein, may be texturized, pelleted and/or medicated.

In still other approaches, young animals are fed whole milk and offered starter feed. According to the present disclosure, feeding systems that use whole milk mean the milk is liquid milk that remains in its naturally liquid state. This is opposed to feeding systems where animals are fed reconstituted milk products (e.g., milk replacers) where milk powders are rehydrated using water. This is also opposed to young animals ingesting milk by suckling from a lactating animal. In its initial state, whole milk is generally her of additives tailored for the young animal, such as milk replacers, balancers, extenders and fortifiers. While the whole milk is generally derived from the same species of animal ingesting the whole milk, this is not a requirement of the present disclosure. Most commonly, young animals are fed whole milk derived from a dairy cow, and while the young animals may be calves (e.g., that eventually mature into dairy cows, bulls or steers), other young animals, such as the broader category of young ruminants, may ingest whole milk prior to weaning. Whole milk may generally be of two different types: saleable milk and non-saleable milk including hospital milk.

Saleable milk is milk that is suitable for selling for human consumption but the producer has chosen to feed the young animals. For instance, saleable milk may be wholesome milk from the cow prior to shipping to a processor. Saleable milk may also be skim milk, 1% fat milk, 2% fat milk, 4% fat milk or combinations thereof that the producer purchases from a retail grocery, wholesale supplier or processor as homogenized milk that has a short expiration date. When saleable milk is located at the producer's facility, the milk may be comingled, meaning the milk total solids, fat and protein levels are unknown.

Non-saleable milk can include squeeze milk, or milk that has passed its shelf-life but is otherwise edible and has been removed from retail sale. Squeeze milk may be obtained by producers through shipments that deliver this milk product. Squeeze milk may be co-mingled when containers are placed in a compression chamber that crushes the containers and collects the milk (hence the term squeeze milk). Other types of non-saleable milk may include milk found with violative residues or that has not passed other inspections such as freezing point depression after it has left the farm but before co-mingling at the milk processor location. Hospital milk is milk that is non-saleable and not suitable for human consumption. It may include colostrum, transition milk, mastitic milk, antibiotic treated milk, i.e. milk from antibiotic treated animals, or high somatic cell count milk.

In prior approaches where the young animals were fed whole milk, producers generally add a fixed amount of a fortifier to ensure the young animal ingests vitamins nutrients and medications required for the animal to grow and stay healthy. The young animal diet tended to be variable in nutritional content, however, the fortifier helped ensure that the young animal remained healthy until the animal was weaned. This approach to feeding young animals can present problems for the animal's overall growth and ability to thrive during adulthood.

Accordingly, the present disclosure provides methods for tailoring the diet of the whole milk-fed young animal by calculating a feed ration for the young animal that includes an admixture of whole milk and additional nutrients incorporated at specific levels in order to feed the young animal a target diet. The methods may be used to deliver a constant level of total solids and nutrients, such as fat and protein. The methods may be performed during the course of a daily feeding program for the young animal or animals, and the steps of the methods may be performed frequently over the course of the program, such as daily; every other day; or multiple times per week, e.g., bi-weekly. The feeding program may last to weaning or until the animal is weaned, which may be about 8 weeks from birth, or the program may end when the animal no longer ingests a diet containing whole milk. Further, the formulation and feeding methods may be performed at a location where the young animals are fed, such as on a farm, ranch or within a research facility.

Exemplary Methods of Formulating Feed Compositions and Feeding Young Animals

Methods involve determining the composition of the whole milk to be fed to the young animal. The composition may include one or more of fat, protein, total solids, density, added water and/or lactose present in the whole milk. The composition may be known for some whole milk products, such as whole milk produced by dairy cows present on a farm where young animals are to be fed.

In other approaches, the composition of the whole milk is unknown, such as when the whole milk is delivered in bulk or when the whole milk is comingled from a number of sources. For instance, non-saleable, squeeze milk may be provided as a mixture of skim, 1%, 2% and/or 4% milk resulting in a variable fat content and variable protein to fat ratio. In another example, hospital milk may be comingled so that the whole milk contains an admixture of colostrum (e.g., containing about 25 percent total solids), fresh milk (e.g., containing about 18 percent total solids) and/or milk produced during normal lactation (e.g., containing about 12.5 percent total solids). Further, water used to flush lines may reach the milk stream. Consequently, whole milk may have a variable total solids content of about 7 to about 15 percent. Accordingly, in some implementations, the whole milk composition is determined using an electronic analyzer that uses ultrasonics, refractometry, near infrared spectrometry (NIR) or variations and combinations thereof. The analyzer may determine the fat, protein, total solids, density, added water and/or lactose present in the whole milk. In some approaches, bench chemistry may additionally or alternatively be used in the compositional analysis. In some preferred approaches, the electronic analyzer is present at the location where the young animals are fed and therefore may be referred to as an on farm analyzer. Particularly, the use of analytical methods at the location where the young animals are fed gives the producer or nutritionist the ability to understand the composition of the whole milk available at any given time and tailor and target the feed ration of the young animal or animals using available additional nutrient sources.

The whole milk composition may be compared to dietary targets for the young animal. Dietary targets generally include a volume of liquid nutrients to be fed per animal per day as well as target total solids and nutrient content to be fed to the animal on a daily basis. For instance, each animal may be fed a volume of about 1.5 to 3.5 liters of liquid per feeding, and the total volume may be delivered once per day, or may be provided into two to three meals or more per day (e.g., up to 10 meals per day when the animal is fed using an automatic feeder). On a dry matter basis, the dietary target may be formulated so that the animal is offered a liquid diet that contains about 0.50 pounds to about 3.0 pounds of total solids per day on a dry matter basis, including but not limited to 0.5, 0.75, 1.0, 1.25, 1.5, 1.75, 2.0, 2.25, 2.5, 2.75 or 3.0 pounds of total solids per animal per day on a dry matter basis. In some preferred approaches, the dietary target may include at least about 1.0 pounds of total solids on a dry matter basis per animal per day up until weaning, or more preferably at least about 1.5 pounds per animal per day. At the onset of weaning and until the young animal is weaned, at least 0.75 pounds of total solids per animal per day may be preferred. The total solids may comprise nutrients such as fat, protein, lactose and ash.

In some implementations, the target diet may include about 10 to about 17 percent total solids on a dry matter basis, including but not limited to 10-14, 11-14, 12-14, 10-15, 11-15, 12-15, 10-16, 11-16, 12-16, 11-17, 12-17, 10, 11, 12, 13, 14, 15, 16 or 17 percent total solids on a dry matter basis. For example, for weaning animals, the target total solids may be about 10-11 percent on a dry matter basis; for pre-weaning animals, the target total solids may be about 12-14 percent on a dry matter basis; for enhanced feeding settings, the target total solids may be about 15-17 percent on a dry matter basis.

A target protein content may be about 20 to about 26 percent of the total solids on a dry matter basis, including but not limited to about 20-25, 20-24, 20-23, 20-22, 21-26, 21-25, 21-24, 21-23, 22-26, 22-25, 22-24, 23-26, 23-25, 24-26, 20, 21, 22, 23, 24, 25 or 26 percent protein as a percent of total solids on a dry matter basis.

A target fat content may be about 16 to about 25 percent of the total solids on a dry matter basis, including but not limited to about 16-24, 16-23, 16-22, 16-21, 16-20, 16-19, 16-18, 18-25, 18-24, 18-22, 18-20, 20-25, 20-24, 20-22, 16, 17, 18, 19, 20, 21, 22, 23, 24 or 25 percent protein as a percent of the total solids on a dry matter basis.

The dietary targets may be selected based on the growth goal the producer or nutritionist has for the young animal. For instance, in traditional settings, young animals may be fed at a lower feeding rate so that the animal grows nominally in size and weight. In another example, in enhanced settings, young animals may be fed at an enhanced feeding rate to achieve elevated growth in frame size and weight. According to a particular aspect of the present disclosure, the young animal may be fed at a selected protein and fat level and a selected ratio of whole milk to additional nutrients that results in the young animal ingesting starter feed at an enhanced rate in order to achieve improved performance such as improved feed intake, gain in frame size and/or weight gain.

According to this aspect, a dietary target of about 0.75 lbs. total solids per feeding, with protein at about 24 to about 26 percent total solids and fat at about 20 to about 22 percent of total solids; where at least about 0.50 lbs. of the total solids is from whole milk and the remainder from an admixed additional nutrient source, such as a high protein content milk replacer or balancer.

Based on the comparison of the whole milk composition and the dietary target, one or more additional nutrients may be identified for use in combination with the whole milk. The additional nutrients may contain protein, fat, lactose, other solids such as ash, vitamins, minerals, medications or combinations thereof. The additional nutrients may be in powder or liquid form and may be adapted for being incorporated in an aqueous solution. In some preferred approaches, the additional nutrients are in powder form. The additional nutrients may be contained within a milk replacer, an extender, a fortifier or a balancer. In some implementations, a milk replacer may serve as an extender and/or as a balancer. For instance, a milk replacer that contains 20 percent protein and 20 percent fat of total solids may serve as an extender, while a milk replacer that contains 25 percent protein and 10 percent fat of total solids may serve as a balancer. Protein in milk replacers may be all milk proteins, plant-based proteins or a combination. Fat in milk replacers may be derived from milk, lard, tallow, vegetable oils or a combination.

Extenders generally add volume and a similar or equal level of nutrients (e.g., near equal or equal amounts of fat and protein) to the whole milk-based diet of the animal. Extenders may contain about 20 to 22 percent protein of total solids, including but not limited to 20, 21 or 22 percent protein and about 18 to about 20 percent fat of total solids, including but not limited to about 18, 19 or 20 percent fat. Fortifiers generally add vitamins, minerals, nutrients and/or medications to the diet of the animal but typically are provided in amounts that are relatively insignificant for purposes of increasing volume. Balancers generally add both volume and balance nutrients in the whole-milk based diet of the animal. For instance, where an elevated protein level relative to a fat level needed to reach the target diet, the balancer may contain more protein than fat, to reach a target feeding level such as 26 percent protein and 20 percent fat of total solids. Balancers contain about 23 to about 25 percent protein of total solids, including but not limited to about 23, 24 or 25 percent protein, and about 7 to about 10 percent fat of total solids, including but not limited to about 7, 8, 9, or 10 percent fat, and generally contain unequal amounts of these nutrients. In alternative examples, balancers may contain relatively more fat than protein. Some nutritionists may attempt to provide milk replacers that attempt to mimic whole milk where the protein and fat on a dry matter basis are 26% and 31% respectively. In other cases, the milk replacer can have the fat percent be equal to the protein such as a 24% protein and 24% fat milk replacer or slightly higher like a 22% fat and 20% protein on a dry matter basis. In extremely cold weather feeding, a producer or nutritionist may elect to feed a milk replacer with very high fat so that the animal receives additional energy. If a milk source is known to contain very low levels of fat, it may be advantageous to supplement the milk powder or liquid with a high fat powder. For example, if a farm has an abundant supply of liquid whey or skim milk, this feed would need additional fat. In some implementations, fortifiers may be present in extenders and balancers.

Continuing with the particular example of the dietary target of about 0.75 lbs. total solids per feeding, with protein at about 24 to about 27 percent of total solids and fat at about 20 to about 23 percent of total solids, the additional nutrients may be calculated based on the amount of available whole milk. Where whole milk accounts for about ⅔ of the total solids in the liquid diet (e.g., 0.5 lbs. per feeding), and an analysis determines the whole milk contains protein at about 27 percent of solids and fat at about 29 percent of total solids, and the additional nutrient accounts for about ⅓ of the liquid diet (e.g., 0.25 lbs. per feeding), the additional nutrient in the form of a balancer or a milk replacer with about 24 percent protein and about 7 percent fat may be admixed with the whole milk to reach the dietary target. In some implementations, the protein:fat ratio of 1.2+/−0.05 may additionally be used in the dietary target calculation.

The preceding example is not limiting with respect to the level of total solids, the level of whole milk and additional nutrient source in the admixture or the level of solids derived therefrom. For instance, the level of total solids per feeding may be about 0.50 pounds to about 3.0 pounds, including but not limited to 0.50, 0.75, 1.0, 1.25, 1.5, 1.75, 2.0, 2.25, 2.5, 2.75 or 3.0 pounds of total solids on a dry matter basis. Whole milk in the admixture may account for about 20 to about 90 percent (including but not limited to 20-30, 20-40, 20-50, 20-60, 20-70 or 20-80 percent), about 30 to about 90 percent (including but not limited to 30-40, 30-50, 30-60, 30-70 or 30-80 percent), about 40 to about 90 percent (including but not limited to 40-50, 40-60, 40-70 or 40-80 percent), about 50 to about 90 percent (including but not limited to 50-60, 50-70 or 50-80 percent), or about 60 to about 90 percent (including but not limited to 60-70 or 60-80 percent) of the admixture. Solids from whole milk may account for about 20 to about 90 percent (including but not limited to 20-30, 20-40, 20-50, 20-60, 20-70 or 20-80 percent), about 30 to about 90 percent (including but not limited to 30-40, 30-50, 30-60, 30-70 or 30-80 percent), about 40 to about 90 percent (including but not limited to 40-50, 40-60, 40-70 or 40-80 percent), about 50 to about 90 percent (including but not limited to 50-60, 50-70 or 50-80 percent), about 60 to about 90 percent (including but not limited to 60-70 or 60-80 percent), about 70 to about 90 percent (including but not limited to 70-80 percent) or about 80 to 90 percent of the total solids in the admixture. Conversely, solids from the additional nutrient source may account for the balance of the total solids in the admixture, such as about 10 to 80 percent (including but not limited to 10-20, 20-30, 30-40, 40-50, 50-60, 60-70, 10-30, 20-40, 30-50, 40-60, 50-70, 10-40, 20-50, 30-60, 40-70, 10-50, 20-60, 30-70, 10-60, 20-70, or 10-70 percent) of the total solids in the admixture.

The additional nutrients required to reach the animal dietary target may be admixed with the available whole milk and water. Water helps achieve a desired volume when the solids density of the admixture exceeds the target solids content in the diet. Mixing may occur on a daily basis, such as once per day, twice per day or three times per day, and may be based on the number of feedings the young animal is to receive per day. Prior to or after mixing, the whole milk may be pasteurized (e.g., using on farm pasteurization) or may re-pasteurized where the milk was previously pasteurized (e.g., when squeeze milk is used in the diet).

Because the composition of available whole milk may change, the composition may be analyzed on a regular basis. For instance, the milk composition may be analyzed each time a whole milk shipment is received. In addition or alternatively, the milk composition may be analyzed periodically over the course of a feeding program, such as daily; every other day; or multiple times per week, e.g., bi-weekly.

In addition, the volume of available whole milk may change resulting in the need to reformulate the young animal's liquid diet in order to reach the target diet. The available volume needed may change based on the number of young animals ingesting a liquid diet, the volume of milk received in a shipment, and/or the availability of hospital milk. In a particular example, the number of young animals ingesting the liquid diet, or their volume requirements, may change on a daily basis. For instance, animals beginning a weaning phase may require fewer feedings per day compared to a previous day; weaned animals may no longer require a whole milk-based diet; and/or young animals may die or may be removed from the feeding program which may be administered in a group feeding setting. When milk is shipped to a farm, the volume of milk may vary depending on availability. Hospital milk volume may vary depending on the number of dairy cows producing hospital milk each day. Thus, while some liquid diets may contain 90 percent or more whole milk, the volume of available whole milk for use in feeding the young animal may vary based on availability, and may be as low as 20-30 percent; and recalculating the liquid diet may therefore be done on a regular basis. This recalculation ensures the animal consistently receives the nutrients needed to reach the target growth goal. Moreover, in certain cases, whole milk may be unavailable for a brief period during the feeding program, and the young animals may be required to ingest a liquid diet of milk replacers alone or in combination with other balancers, extenders or fortifiers. In this situation, the animal continues to benefit due to formulating the target diet with the same total solids, fat and protein as when the diet contains whole milk, and once whole milk is available, the whole milk is seamlessly incorporated back into the target diet while delivering a constant solids and nutrient level throughout the program.

Admixtures of whole milk and additional nutrients prepared according to the present disclosure may be regularly fed to the young animals prior to being weaned. Delivery of the admixture to the young animal may be according to conventional approaches including using a bucket, bottle or auto-feeder. Starter feed may be delivered using conventional approaches. Starter feed may contain about 18 to about 22 percent crude protein, may be texturized, pelleted and/or medicated. Typical forms of a starter are texturized and pelleted. Texturized starters are made up of whole grains that are easily identified and also contain a pellet that contains minerals, vitamins and protein. Pelleted starters are ground feed that is tightly compressed, and when used, it is preferred that these contain low levels of fines.

Continuing still with the particular example of the admixture containing the dietary target of about 0.75 lbs. total solids per feeding, with protein at about 24 to about 27 percent solids and fat at about 20 to about 23 percent of solids, it has been discovered that young animals, particularly calves, ingesting the admixture twice per day prior to weaning and once per day during weaning are caused to intake elevated levels of starter feed offered ad libitum. The elevated starter intake may be an increase of starter intake as a percentage of the total dry matter in the diet (e.g., the combination of dry matter from solids in the admixture and dry matter of the starter), an increased average daily starter intake, an increased overall dry matter intake and/or an increase daily dry matter intake until the young animal is weaned, as compared to young animals fed milk replacer alone, and/or as compared to young animals fed whole milk alone. The preceding example of a diet that results in improved performance is not limiting with respect to the particular total solids, fat and protein level in the target diet; and young animals, such as calves, fed the admixtures formulated according to the present disclosure may increase starter intake as a percentage of total dry matter intake until weaned by at least about 10 percent or about 15 percent as compared to young animals fed milk replacer alone, and/or by at least about 5 percent as compared to young animals fed whole milk alone. Young animals, such as calves, fed the admixtures of the present disclosure may increase average daily starter intake until weaned by at least about 30 percent or about 35 percent as compared to young animals fed milk replacer alone, and/or by at least about 15 percent or 20 percent as compared to young animals fed whole milk alone. Young animals, such as calves, fed the admixtures of the present disclosure may increase overall dry matter intake (by ingesting both starter and the admixture) and/or dry matter intake on a daily basis by at least about 15 percent or about 20 percent as compared to young animals fed milk replacer alone, and/or by at least about 10 percent as compared to young animals fed whole milk alone.

Due to the ingestion of the admixture and the elevated level of starter feed according to the present disclosure, the young animals may experience improved performance. For instance, young animals, such as calves, ingesting the admixtures and starter according to the present disclosure may increase average daily gain by at least about 15 percent or about 20 percent as compared to young animals fed milk replacer alone, and/or by at least about 3 percent as compared to young animals fed whole milk alone. In addition or alternatively, young animals, such as calves, may gain weight by at least about 15 or about 20 percent as compared to young animals fed milk replacer alone, and/or by at least about 3 percent as compared to young animals fed whole milk alone. In addition or alternatively, young animals, such as calves, may gain in hip height by at least about 15 or about 20 percent as compared to young animals fed milk replacer alone, and/or by at least about 3 percent as compared to young animals fed whole milk alone.

Moreover, the improved performance may extend past weaning, and ingestion of the admixture and the elevated level of starter feed according to the present disclosure, may result in animals experiencing increased average daily gain and increased gain in hip height 28 days or more after weaning.

It is believed that animals ingesting the admixture and starter feed according to the present disclosure do not experience negative health effects.

When non-saleable milk, such as hospital milk is used in combination with balancers, extenders and/or milk replacers, the cost per gain in height and/or weight may be markedly lower than the cost of feeding using milk replacer alone or saleable milk alone. Even where the cost per gain in height and/or weight is the same or more when animals are fed an admixture of whole milk and milk replacer and offered starter ad libitum, the increased starter intake and the resulting increased gain in weight and height can result in improvements in overall animal management because the animal may mature faster, reproduce faster, reach a weight for slaughter faster or combinations of these. Further, animals that have a more functional rumen as a result of incremental and total starter intake improvements have been shown to have a smoother and healthier transition into group pens.

Example: The following non-limiting example provides an approach for feeding young animals in a daily feeding program that results in increased starter intake and improved performance. This example evaluates the health and performance of calves fed two kinds of milk replacer versus pasteurized waste milk with or without a milk replacer supplement. The nutrient content and availability of waste milk can vary greatly from day to day. On a dry matter basis, waste milk will often be much higher in protein and fat concentration than a conventional milk replacer 26/31 vs. 20/20, respectively.

Materials and Methods:

100 Holstein heifer calves at least 24 hours of age and having been fed at least three meals were used in the study. The study lasted 56 days. All calves were fed an 18% crude protein texturized calf starter medicated with decoquinate at 45 grams/ton. Calf starter and water were offered free choice from day 1 to day 56. All calves were fed diflubenzuron (Elim-A-Fly™) at a rate of 0.10 mg/kg of body weight/day in the milk.

The calves were randomly divided into four treatments by source and body weight, and each treatment contained 25 calves. In the first treatment (CON) calves were fed a 20% protein:20% fat non-medicated all-milk protein milk replacer (MR) at 0.75 lbs. in 5.25 lbs. water (12.5% solids) twice daily for 42 days and once daily from day 43 to weaning at 49 days. In the second treatment (MRS) calves were fed a non-medicated all milk protein milk replacer containing 26% protein and 31% fat at 0.75 lbs. solids twice daily as in the first treatment. The milk replacer of the second treatment was formulated to include additional essential fatty acids. In the third treatment (WM) calves were fed pasteurized waste milk at 0.75 lbs. solids twice daily as in the first treatment, actual feeding rates were adjusted based on refractometer reading that estimated total solids; and actual solids were verified with lab tests on occasion throughout the study. In the fourth treatment (WMS) calves were fed pasteurized waste milk at 0.50 lbs. of solids and 0.25 lbs. of a 24% protein:7% fat all milk protein milk replacer with added water as needed to adjust the solids content to reach a constant mix of 12.5% solids and fed twice daily as in the first treatment. The milk replacer was formulated to include proper levels of vitamins and fat sources. The resulting protein and fat percent in the balanced milk fed was about 25.5% and 21.5% respectively when the whole milk protein and fat were 26.6% and 29% respectively. The final fed mix changed proportionate to the whole milk protein and fat changes but was safely within that range of a protein:fat ratio of 1.2+/−0.05.

Milk Collection/Pasteurizer Procedures: Milk was picked up from a farm 2 to 3 days each week during the study. Milk samples were taken from a bulk tank after proper agitation each time a load is picked up and dropped off and a nutrient and solids analysis was taken. A milk sample was taken and frozen from each load of milk for bacteria analysis before pasteurization. A sample was taken and frozen from the first and last batch of milk pasteurized from each load. A Brix refractometer reading was taken from each load of milk to estimate solids content and feeding rate was based on this reading. All milk samples were kept cooled or placed in a freezer as soon as possible after collection. Clean collection tubes were used to hold samples. Waste milk was stored and cooled to 40 degrees and pasteurized before each feeding. The bulk tank was emptied and washed the day new milk comes in.

Data Collection: Amount fed of all feed was recorded daily and summarized every 2 weeks by treatment. Milk refusals were recorded at each feeding and summarized bi-weekly. Starter refusals were measured and recorded weekly, intake totals summarized by week. Body weight was measured initially and at the end of day 14, 28, 42, 49 and 56 of the trial. Hip height was taken on day 1 and day 56 of trial. Fecal Scores were recorded daily and summarized weekly by treatment through 4 weeks of age. (1-4 scale, with 1=normal, 2=loose, pudding, 3=very loose, no watery separation, and 4=very watery). Health, treatment, and death loss records were recorded on an individual calf basis. Diagnosis, treatment, date, and product used were recorded. If death loss occurs, date and cause(s), if known, were noted as well as the animal weight. Blood samples were taken from each calf upon arrival and analyzed for serum protein concentration. Feed samples were taken directly from bags of milk replacer and calf starter weekly, properly labeled and frozen for subsequent analyses. Treatment days and cost were recorded for each treated calf.

Calf Management: Calves were offered milk replacer twice per day by bucket with a nipple bottle offered when intake was a concern. Fresh water was available at all times. Starter was offered starting on the first day of the study. Refused amounts were recorded daily.

Results: The results of this example are provided in Tables 1, 2A, 2B and 3. Table 1 provides the growth parameters of the calves fed over the course of the 56 day study.

TABLE 1
Growth Parameters day 1 to 56.

| | 1 | 2 | 3 | 4 | SEM |
|---|---|---|---|---|---|
| Number | 26 | 27 | 26 | 26 | |
| Initial BW¹, lb. | 85.4 | 85.4 | 85.4 | 85.3 | 1.60 |
| Initial HH², in | 31.68 | 31.67 | 31.30 | 31.62 | 0.20 |

BW, Lb.

| | | | | | |
|---|---|---|---|---|---|
| d 14 | 96.5^{a} | 97.5^{a} | 103.0^{b} | 102.7^{b} | 2.05 |
| d 28 | 113.7^{a} | 117.1^{a} | 123.9^{b} | 124.9^{b} | 2.05 |
| d 42 | 140.3^{a} | 140.5^{a} | 153.0^{b} | 157.0^{b} | 2.05 |
| d 49 | 156.9^{a} | 154.5^{a} | 170.8^{b} | 174.9^{b} | 2.05 |
| d 56 | 175.1^{a} | 173.0^{a} | 188.7^{b} | 192.3^{b} | 2.05 |
| d 84 | 230.5^{a} | 227.6^{a} | 247.6^{b} | 249.0^{b} | 4.23 |

ADG, lb./d

| | | | | | |
|---|---|---|---|---|---|
| d 1 to 14 | 0.85^{a} | 0.92^{a} | 1.33^{b} | 1.31^{b} | 0.09 |
| d 15 to 28 | 1.21^{a} | 1.39^{ab} | 1.46^{b} | 1.56^{b} | 0.09 |
| d 29 to 42 | 1.87^{ab} | 1.66^{b} | 2.05^{ac} | 2.27^{cd} | 0.09 |
| d 43 to 49 | 2.35^{a} | 1.98^{b} | 2.52^{a} | 2.52^{a} | 0.09 |
| d 1 to 49 | 1.46^{a} | 1.41^{a} | 1.75^{b} | 1.83^{b} | 0.05 |
| d 50 to 56 | 2.59 | 2.63 | 2.53 | 2.47 | 0.09 |
| d 1 to 56 | 1.60^{a} | 1.57^{a} | 1.84^{b} | 1.91^{b} | 0.05 |
| d 57 to 84 | 1.99 | 1.95 | 2.12 | 2.04 | 0.09 |

Total BW gain, lb

| | | | | | |
|---|---|---|---|---|---|
| d 1 to 14 | 12.0^{a} | 12.8^{a} | 18.6^{b} | 18.4^{b} | 0.94 |
| d 15 to 28 | 17.0^{a} | 19.4^{b} | 20.5^{b} | 21.9^{b} | 0.94 |
| d 29 to 42 | 26.3^{a} | 23.2^{b} | 28.8^{c} | 31.8^{d} | 0.94 |
| d 43 to 49 | 16.3^{a} | 13.7^{b} | 17.5^{a} | 17.5^{a} | 0.94 |
| d 1 to 49 | 71.6^{a} | 69.3^{a} | 85.6^{b} | 89.6^{b} | 2.50 |
| d 50 to 56 | 18.0 | 18.3 | 17.5 | 17.1 | 0.94 |
| d 1 to 56 | 89.7^{a} | 87.7^{a} | 103.1^{b} | 106.8^{b} | 2.95 |

HH, in

| | | | | | |
|---|---|---|---|---|---|
| d 56 | 35.82^{a} | 35.94^{a} | 36.60^{b} | 36.79^{b} | 0.15 |
| d 84 | 38.85^{a} | 38.67^{a} | 39.56^{b} | 39.77^{b} | 0.21 |

HH gain, in

| | | | | | |
|---|---|---|---|---|---|
| d1 to d 56 | 4.24^{a} | 4.37^{a} | 5.02^{b} | 5.22^{b} | 0.15 |

¹Initial body weight (BW) utilized as a covariate for body weight, ADG and intake data when significant.
²Initial hip height (HH) utilized as a covariate for hip height (d56) and HH gain when significant.
^{abc}Means in same row with different superscripts differ (P < .05)

The results of Table 1 show calves fed according to the present disclosure in the fourth treatment improved performance in both body weight and hip height numerically more than the other treatments. With respect to the weight of the calves, the calves in the fourth treatment group at day 56 were statistically heavier, had a statistically higher average daily gain and gained statistically more weight, than calves fed milk replacers alone in the first and second treatment groups. The calves of the fourth treatment group were heavier and had a higher average daily gain than calves fed whole milk alone in the third treatment group.

Improved body weight growth continued after the study and calves in the fourth treatment group at day 84 (e.g., 28 days after the study ended). During days 57 to 84, the calves were ingesting a diet of forage and grain, and were again statistically heavier than calves fed milk replacers alone in the first and second treatment groups, and heavier than calves fed whole milk alone in the third treatment group ingesting the same diet of forage and grain. In addition, calves in the fourth treatment group from days 57 to 84 had an increased average daily gain over calves in the first and second treatment groups.

With respect to the height of the calves, based on hip height, the calves in the fourth treatment group at day 56 were statistically taller and grew statistically more in height than calves fed milk replacers alone in the first and second treatment groups. The calves of the fourth treatment group were taller and grew more in height than calves fed whole milk alone in the third treatment group.

Improved height growth continued after the study and calves in the fourth treatment group at day 84 (e.g., 28 days after the study ended) were again statistically taller, based on hip height, than calves fed milk replacers alone in the first and second treatment groups, and taller than the calves fed whole milk alone in the third treatment group.

Table 2A provides milk replacer intake, starter intake as a percent of total dry matter, and overall starter intake.

TABLE 2A
Milk Replacer, starter and total DM intake and feed efficiency.

| | | | | |
|---|---|---|---|---|
| 1 | 2 | 3 | 4 | SEM |

Milk Replacer
DM %
Total MR
intake, lbs. DM

| | | | | | |
|---|---|---|---|---|---|
| d 1 to 14 | 19.57 | 19.58 | 19.93 | 20.08 | 0.07 |
| d 15 to 28 | 20.24 | 20.35 | 20.10 | 20.09 | 0.07 |
| d 29 to 42 | 20.28 | 20.36 | 20.26 | 20.20 | 0.07 |
| d 43 to 49 | 5.03 | 5.06 | 5.04 | 5.04 | 0.07 |
| d 1 to 49 | 65.16 | 65.37 | 65.37 | 65.44 | 0.15 |

MR
Intake, lb./d DM

| | | | | | |
|---|---|---|---|---|---|
| d 1 to 14 | 1.40 | 1.40 | 1.42 | 1.43 | 0.005 |
| d 15 to 28 | 1.45 | 1.45 | 1.40 | 1.43 | 0.005 |
| d 29 to 42 | 1.45 | 1.45 | 1.45 | 1.44 | 0.005 |
| d 43 to 49 | 0.72 | 0.73 | 0.72 | 0.72 | 0.005 |
| d 1 to 49 | 1.33 | 1.33 | 1.33 | 1.34 | 0.003 |

Starter
DM %
Intake, lbs. DM

| | | | | | |
|---|---|---|---|---|---|
| d 1 to 7 | 0.11^{a} | 0.17^{a} | 0.36^{ab} | 0.51^{b} | 0.14 |
| d 8 to 14 | 0.40 | 0.66 | 0.75 | 0.86 | 0.22 |
| d 15 to 21 | 1.72^{a} | 1.65^{a} | 2.09^{ab} | 2.91^{b} | 0.40 |
| d 22 to 28 | 4.00^{a} | 3.81^{a} | 4.31^{a} | 6.71^{b} | 0.54 |
| d 29 to 35 | 7.83^{a} | 5.94^{b} | 7.12^{ab} | 11.39^{c} | 0.68 |
| d 36 to 42 | 11.94^{a} | 8.76^{b} | 12.42^{a} | 17.36^{c} | 0.82 |
| d 43 to 49 | 22.46^{a} | 17.66^{b} | 24.17^{a} | 28.56^{c} | 0.91 |
| d 50 to 56 | 36.16^{a} | 32.47^{b} | 36.61^{a} | 39.77^{c} | 1.01 |

Starter
intake, lbs. DM

| | | | | | |
|---|---|---|---|---|---|
| d 1 to 49 | 46.77^{a} | 37.67^{b} | 48.93^{a} | 66.39^{c} | 3.52 |
| d 50 to 56 | 36.16^{a} | 32.47^{b} | 36.61^{a} | 39.77^{c} | 1.01 |
| d 1 to 56 | 82.80^{a} | 70.10^{b} | 85.30^{a} | 105.97^{c} | 4.59 |

^{abc}Means in same row with different superscripts differ (P < .05)

The results of Table 2A show calves fed according to the present disclosure had similar intake of the liquid diet overall and on a daily basis, on a dry matter basis, compared to the calves fed in the other three treatment groups.

Table 2A additionally shows the starter intake as a percent of dry matter intake, and starter intake on a periodic basis of days 1-49, days 50-56 and days 1-56. Starter intake as a percentage of overall dry matter for the fourth treatment group was higher compared to the other three treatment groups, was statistically higher for the periods running from days 1-7, 15-21 and 22-28 compared to calves ingesting milk replacers in the first and second treatment groups; and starting at the period from days 29 to 35 and extending to the end of the study, starter intake as a percentage of overall dry matter for the fourth treatment group was statistically higher compared to the other three treatment groups. Therefore, as expected, starter intake for the fourth treatment group was statistically higher compared to the other three treatment groups for the periods including days 1-49, days 50-56 and days 1-56.

Table 2B includes results for starter intake per animal per day, overall dry matter intake, dry matter intake per animal per day.

TABLE 2b
Milk Replacer, starter and total DM intake and feed efficiency.

| | | | | |
|---|---|---|---|---|
| 1 | 2 | 3 | 4 | SEM |

Total Starter
Intake, lbs./d

| | | | | | |
|---|---|---|---|---|---|
| d 1 to 7 | 0.02^{a} | 0.02^{a} | 0.05^{ab} | 0.07^{b} | 0.02 |
| d 8 to 14 | 0.06 | 0.09 | 0.11 | 0.12 | 0.03 |
| d 15 to 21 | 0.25^{a} | 0.24^{a} | 0.30^{ab} | 0.42^{b} | 0.06 |
| d 22 to 28 | 0.57^{a} | 0.54^{a} | 0.62^{a} | 0.96^{b} | 0.08 |
| d 29 to 35 | 1.12^{a} | 0.85^{b} | 1.02^{ab} | 1.63^{c} | 0.10 |
| d 36 to 42 | 1.71^{a} | 1.25^{b} | 1.77^{a} | 2.48^{c} | 0.10 |
| d 43 to 49 | 3.21^{a} | 2.52^{b} | 3.45^{a} | 4.08^{c} | 0.13 |
| d 50 to 56 | 5.17^{a} | 4.64^{b} | 5.23^{a} | 5.68^{c} | 0.15 |

Total Starter
Intake, lbs./d

| | | | | | |
|---|---|---|---|---|---|
| d 1 to 49 | 0.95^{a} | 0.77^{b} | 1.00^{a} | 1.35^{c} | 0.07 |
| d 50 to 56 | 5.17^{a} | 4.64^{b} | 5.23^{a} | 5.68^{c} | 0.19 |
| d 1 to 56 | 1.48^{a} | 1.25^{b} | 1.52^{a} | 1.89^{c} | 0.08 |

DM intake, lbs.

| | | | | | |
|---|---|---|---|---|---|
| d 1 to 14 | 19.78 | 20.24 | 20.63 | 21.11 | 1.03 |
| d 15 to 28 | 25.65^{a} | 25.64^{a} | 26.09^{a} | 29.36^{b} | 1.03 |
| d 29 to 42 | 39.76^{a} | 34.89^{b} | 39.40^{a} | 48.61^{c} | 1.03 |
| d 43 to 49 | 27.21^{a} | 22.55^{b} | 28.81^{a} | 33.26^{c} | 1.03 |
| d 1 to 49 | 111.93^{a} | 103.03^{b} | 114.30^{a} | 131.84^{c} | 3.56 |
| d 50 to 56 | 35.83^{a} | 32.45^{b} | 36.16^{a} | 39.40^{c} | 1.03 |
| d 1 to 56 | 147.92^{a} | 135.63^{b} | 150.63^{a} | 171.37^{c} | 4.60 |

DM intake, lbs./d

| | | | | | |
|---|---|---|---|---|---|
| d 1 to 14 | 1.41 | 1.44 | 1.47 | 1.50 | 0.12 |
| d 15 to 28 | 1.83 | 1.83 | 1.86 | 2.09 | 0.12 |
| d 29 to 42 | 2.84^{a} | 2.49^{b} | 2.81^{a} | 3.47^{c} | 0.12 |
| d 43 to 49 | 3.91^{a} | 3.24^{b} | 4.14^{a} | 4.77^{c} | 0.12 |
| d 1 to 49 | 2.28^{a} | 2.10^{b} | 2.33^{a} | 2.69^{c} | 0.07 |
| d 50 to 56 | 5.14^{a} | 4.65^{b} | 5.19^{a} | 5.65^{c} | 0.18 |
| d 1 to 56 | 2.64^{a} | 2.42^{b} | 2.69^{a} | 3.06^{c} | 0.08 |

^{abc}Means in same row with different superscripts differ (P < .05)

The results of Table 2B show total starter intake for the fourth treatment group was higher compared to the other three treatment groups; was statistically higher for the periods running from days 1-7, 15-21 and 22-28 compared to calves ingesting milk replacers in the first and second treatment groups; and starting at the period from days 29 to 35 and extending to the end of the study, overall starter intake for the fourth treatment group was statistically higher compared to the other three treatment groups.

Therefore, as expected, average daily starter intake in the fourth treatment group was statistically higher compared to the other three treatment groups for the periods including days 1-49, days 50-56 and days 1-56.

With respect to overall dry matter intake, which is the combination of dry matter in the liquid feed and the dry matter of the starter feed, dry matter intake for the fourth treatment group was higher compared to the other three treatment groups; was statistically higher for the period running from days 15-28 compared to calves ingesting milk replacers in the first and second treatment groups; and starting at the period from days 29 to 42 and extending to the end of the study, dry matter intake for the fourth treatment group was statistically higher compared to the other three treatment groups.

With respect to average daily dry matter intake, the fourth treatment group ingested more dry matter compared to the other three treatment groups; and starting at the period from days 29 to 42 and extending to the end of the study, average daily dry matter intake for the fourth treatment group was statistically higher compared to the other three treatment groups.

Table 3 includes the results for feed efficiency, serum protein and health data for the animals in the different treatment groups.

TABLE 3
Feed efficiency, serum protein and health data.

| | | | | |
|---|---|---|---|---|
| 1 | 2 | 3 | 4 | SEM |

Gain per Feed

| | | | | | |
|---|---|---|---|---|---|
| d 1 to 14 | 0.61^{a} | 0.63^{a} | 0.90^{b} | 0.86^{b} | 0.026 |
| d 15 to 28 | 0.66^{a} | 0.75^{b} | 0.78^{b} | 0.75^{b} | 0.026 |
| d 29 to 42 | 0.66^{a} | 0.67^{a} | 0.74^{b} | 0.66^{a} | 0.026 |
| d 43 to 49 | 0.61^{a} | 0.60^{a} | 0.62^{a} | 0.52^{b} | 0.026 |
| d 1 to 49 | 0.64^{a} | 0.67^{b} | 0.75^{c} | 0.68^{b} | 0.01 |
| d 50 to 56 | 0.50^{ab} | 0.57^{b} | 0.49^{a} | 0.44^{a} | 0.026 |
| d 1 to 56 | 0.61^{a} | 0.65^{b} | 0.69^{c} | 0.63^{a} | 0.008 |
| Serum | 5.70 | 5.70 | 5.76 | 5.79 | 0.15 |
| Protein | | | | | |

Fecal Score¹

| | | | | | |
|---|---|---|---|---|---|
| d 1 to 14 | 1.68 | 1.72 | 1.57 | 1.57 | 0.05 |
| d 15 to 28 | 1.32 | 1.36 | 1.26 | 1.24 | 0.05 |
| d 29 to 42 | 1.07 | 1.03 | 1.07 | 1.11 | 0.05 |
| d 43 to 49 | 1.09 | 1.10 | 1.09 | 1.06 | 0.05 |
| d 1 to 49 | 1.32 | 1.33 | 1.28 | 1.28 | 0.03 |
| d 50 to 56 | 1.24 | 1.13 | 1.38 | 1.16 | 0.05 |
| d 1 to 56 | 1.31 | 1.31 | 1.29 | 1.26 | 0.03 |

Scouring days²

| | | | | | |
|---|---|---|---|---|---|
| # Days ≧3 | | | | | |
| d 1 to 42 | 2.57 | 3.28 | 2.29 | 1.91 | 0.48 |
| d 43 to 56 | 0.09^{a} | 0.11^{a} | 0.48^{b} | 0.10^{a} | 0.12 |
| # Days = 4 | | | | | |
| d 1 to 42 | 0.22^{a} | 0.65^{b} | 0.29^{a} | 0.21^{a} | 0.13 |

Treatment cost, $

| | | | | | | |
|---|---|---|---|---|---|---|
| d 1 to 42 | 0.29 | 0.75 | 0.19 | 0.21 | 0.07 | 0.19 |
| d 43 to 56 | 0.00 | 0.10 | 0.00 | 0.00 | | 0.06 |
| d 1 to 56 | 0.27^{a} | 0.85^{b} | 0.16^{a} | 0.19^{a} | | 0.20 |

BHB mg/dl

| | | | | | |
|---|---|---|---|---|---|
| d28 | 0.07^{a} | 0.13^{b} | 0.10^{ab} | 0.12^{b} | 0.01 |
| d35 | 0.11^{a} | 0.16^{b} | 0.11^{a} | 0.16^{b} | 0.01 |
| d42 | 0.15^{a} | 0.21^{b} | 0.21^{b} | 0.24^{b} | 0.02 |

¹Fecal score = 1 to 4; 1 = normal, 4 = watery
²Scouring day = any day with a fecal score ≧3.
^{ab}Means in same row with different superscripts differ (P < .05)

The results of Table 3 show calves fed in the fourth treatment group did not experience negative health effects as a result of ingesting a diet of an admixture of whole milk and milk replacer compared to the other three treatment groups. Beta-hydroxybutyrate (BHB) levels were higher in the fourth treatment group compared to all other treatments indicating that the calf rumen is more developed and confirms data showing higher starter intake.

Summary: Calves fed in the fourth treatment group ingesting about 1.0 lbs. of solids derived from whole milk and 0.5. lbs. of solids derived from a milk replacer on a daily basis surprisingly improved performance, and inter alia, ingested more starter feed, gained more weight and grew more in height compared to the calves fed milk replacer or whole milk alone. When non-saleable milk, such as hospital milk is used in combination with milk replacers, the cost per gain in height and/or weight is markedly lower than the cost of feeding using milk replacer or saleable milk alone. Even where the cost per gain in height and/or weight is the same or more when animals are fed an admixture of whole milk and milk replacer, the increased starter intake and the resulting increased gain in weight and height can result in improvements in overall animal management because the animal may mature faster, reproduce faster, or reach a weight for slaughter faster as shown by the improved performance of the animals in the fourth treatment group after weaning. Further, animals that have a more functional rumen as a result of incremental and total starter intake improvements have been shown to have a smoother and healthier transition into group pens in a new weaned animal housing environment.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of feeding one or more young animals in a daily feeding program, the method comprising:
on a daily basis, determining a volume of whole milk available for feeding to the one or more young animals in the daily nutrition program, wherein the whole milk comprises one or more of non-saleable milk or saleable milk;
determining a number of the one or more animals to be fed the available whole milk in the program;
in a location where the young animals are fed, determining a compositional level of protein, fat and total solids in the available whole milk;
calculating an amount of at least one additional nutrient source for incorporating with the whole milk to reach an admixture of about 10 to about 17 percent total solids on a dry matter basis, wherein about 20 to about 26 percent of the total solids is protein, and wherein about 16 to about 25 percent of the total solids is fat;
admixing the at least one additional nutrient source with the whole milk; and
feeding the admixture to the one or more young animals in the program,
wherein the volume of the available whole milk, the composition of the available whole milk, and the number of the one or more young animals in the program is variable over a course of the program such that the amount calculated dynamically changes over the course of the program.

2. The method of claim 1, further comprising offering a starter feed comprising grains to the one or more young animals on an ad libitum basis, and wherein in response to ingesting the admixture and starter feed, at least one of the one or more young animals experiences improved performance.

3. The method of claim 1, wherein the admixture comprises about 11 to 14 percent total solids on a dry matter basis.

4. The method of claim 1, wherein at least 30 percent of the admixture is whole milk.

5. The method of claim 1, wherein the admixture contains at least about 0.75 lbs. total solids on a dry matter basis per young animal per feeding, and wherein at least 0.50 lbs. of the total solids is from whole milk.

6. The method of claim 5, wherein at least about 0.25 lbs. of the total solids is from the at least one additional nutrient source comprising one or more of a milk replacer, a balancer or an extender.

7. The method of claim 6, wherein the at least one additional nutrient source comprises the balancer, and wherein the balancer comprises an elevated level of protein relative to a level of fat.

8. The method of claim 5, wherein at least about 30 percent of the admixture is whole milk.

9. The method of claim 1, wherein the young animals are calves and the program ends at weaning.

10. The method of claim 1, wherein the step of determining a compositional level of protein, fat and total solids in the available whole milk comprises analyzing the whole milk using an electronic analyzer at the location.

11. A method of feeding one or more young animals in a feeding program, the method comprising:
in a location where the young animals are fed, analyzing a composition of available whole milk to be fed to the one or more young animals, wherein results of the compositional analysis comprise at least one of fat, protein, total solids or lactose, and wherein the composition of the available whole milk is variable over a course of the feeding program;
using the compositional analysis results to calculate an amount of one or more additional nutrients for incorporating with the available whole milk analyzed to reach an admixture of about 10 to about 17 percent total solids on a dry matter basis, where about 20 to about 26 percent of the total solids is protein, and where about 16 to about 25 percent of the total solids is fat; and
feeding the admixture and a starter feed to the one or more young animals, wherein the starter feed is fed ad libitum, and
wherein in response to ingesting the admixture, the one or more young animals increases starter feed intake, and at least one of the one or more young animals experiences improved performance.

12. The method of claim 11, wherein the improved performance comprises at least one of improved body weight gain, improved average daily gain, improved hip height gain.

13. The method of claim 11, wherein the starter feed includes about 18 percent crude protein.

14. The method of claim 11, wherein the one or more additional nutrients comprises a nutrient powder containing a blend of protein and fat.

15. The method of claim 11, wherein the one or more young animals are one or more calves and the program ends for each calf once weaned.

16. The method of claim 11, wherein the admixture contains at least about 0.75 lbs. total solids on a dry matter basis per young animal per feeding, and wherein at least 0.50 lbs. of the total solids is from whole milk.

17. The method of claim 16, wherein the whole milk accounts for at least about 30 percent of the admixture.

18. The method of claim 11, wherein the at least one additional nutrient source comprises a balancer, and wherein the balancer comprises an elevated level of protein relative to a level of fat.

19. A method of feeding a young animal, the method comprising:
mixing whole milk and at least one of a milk replacer, a balancer or an extender to reach an admixture of about 10 to about 17 percent total solids on a dry matter basis, where about 20 to about 26 percent of the total solids is protein, and where about 16 to about 25 percent of the total solids is fat; and
feeding the admixture and a starter feed to the one or more young animals,
wherein the admixture is fed such that the young animal receives at least 0.75 lbs. of total solids on a dry matter basis per day,
wherein the starter feed is fed ad libitum, and
wherein in response to ingesting the admixture, the one or more young animals increases starter feed intake, and at least one of the one or more young animals experiences improved performance.
